(19) United States
(12) Patent Application Publication
(10) Pub. No.: US 2021/0260914 A1
(43) Pub. Date: Aug. 26, 2021

(54) MULTI-LAYERED ENGRAVING

(71) Applicant: Onyemaechi Ahanotu, Oakland, CA (US)

(72) Inventor: Onyemaechi Ahanotu, Oakland, CA (US)

(21) Appl. No.: 16/798,395

(22) Filed: Feb. 23, 2020

(51) Int. Cl. B44C 3/00

(52) U.S. Cl. CPC B44C 3/005

(57) ABSTRACT

A method for producing patterns, images and features in multilayered materials through a subtractive process using electromagnetic radiation, physical or chemical means. Engraved or etched material is made of multi-layered structures that interact to produce an electromagnetic effect or response.

### BACKGROUND TO INVENTION

Engraving and subtractive processes have been used for thousands of years and rely on the removal of material from either a homogenous material or bi-layer material. Engraving a homogenous material relies on contrast from texture to reveal a pattern or image. Bi-layered engraving may generate contrast through the difference in properties between the two layers (e.g. color, absorptivity, texture), the resultant product is a what is typically referred to as mono-chromatic with one color being the foreground and the other acting as a background. This may be a simple as a single coating selectively removed from a substrate or base material.

Engraving and imprinting both cause physical alteration of target materials.

### DESCRIPTION OF RELATED ARTS

Engraving materials to generate a pattern. Monochrome engraving by engraving through a top coating (e.g. paint, polymer, oxide) to reveal the underlying substrate. Generating a polychromatic pattern through thermal oxide growth on metals; thickness of single material oxide layer dictates color.

### DETAILED DESCRIPTION OF INVENTION

The presented describes a method of generating a patterned multi-layered material. The multi-layers are sufficiently thin layers to allowing for electromagnetic radiation penetration and interaction.

The resultant material may use absorption, emission, reflection, refraction, scattering, or diffraction of electromagnetic waves to produce a designed effect. The material is processed in a way that either completely or partially removes target layer material. Remaining layers and material interact to generate a pattern.

Material may be removed using single or multiple steps. Removal can be achieved through mechanical, chemical or physical removal through any combination of scrapping, vaporizing, sublimating, melting, delaminating, exploding and etching. Engraving or subtractive fabrication process may result in a partial or complete blending of remaining layers. In a stack of Layer A, B and C— described processing may combine residual Layer A with adjacent Layer B to yield a new hybrid or gradient Layer A-B. Processed material may then be used as the final object or further processed through deposition of additional layers.

Digital gray scale pattern may be used to create a multi-chromatic product. Gray scale values of a pattern represent physical parameters. Physical parameters may include, engraver power, speed, dwell time, position, or wavelength. Physical parameter imparts a physical change to the target multi-layer. Gray scale pattern may be used in a single pass, repeated multiple passes or repeated passes for independent channels. Patterns may be created specifically or nonspecifically.

### DESCRIPTION OF FIGURES

FIG. 1. Cross sectional schematic of example multilayers prior to being subjected to processing. Examples include additive, subtractive or particular composite.

FIG. 2. Schematic of processing step, removing material from multilayers shown in FIG. 1

FIG. 3. Cross sectional schematic of the result of multilayer processing illustrating physical modification of the original multilayer system.

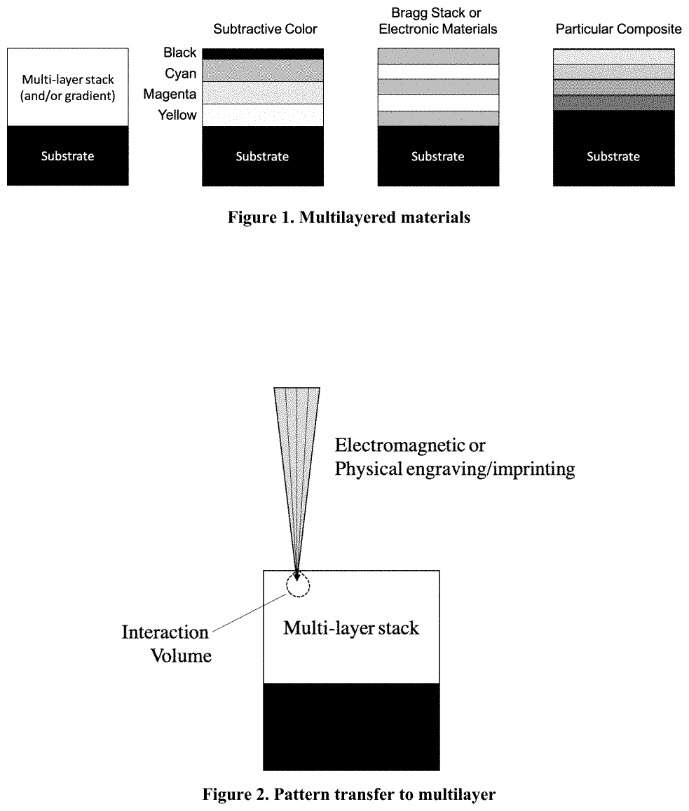

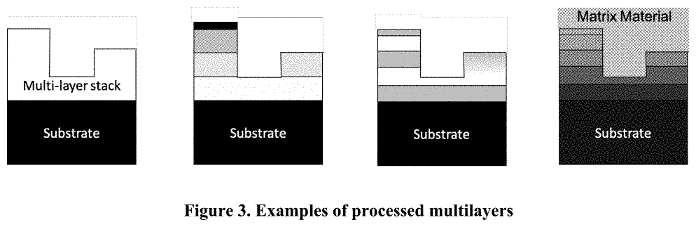

1. A process to create a patterned multilayer through subtractive means to reveal varying degrees of the multi-layer material stack:
a. Freestanding multilayer or bound to a substrate;
b. Physical removal of material using electromagnetic, chemical or physical means.

2. Multi-layer subjected to claim (1b) consists of layers made wholly or in part of polymer, oxides, semi-conductor, metal or composite material:
a. Multi-layer material or composite may be partly or fully removed, leaving behind matrix material or void;
b. Multi-layers may produce electromagnetic effect through additive, subtractive, reflective, refractive, diffracted and/or scattering means;
c. Multi-layer subject to process of claim (1b) may form partially or fully mixed layers giving hybrid properties of the mixed or gradient layers.

3. A physical multi-chromatic pattern created from digital gray-scale pattern(s)
a. Pattern may be created from independent channels and/or a single channel can produce a multi-color image
